(19) United States
(12) Patent Application Publication
(10) Pub. No.: US 2016/0345770 A1
(43) Pub. Date: Dec. 1, 2016

(54) PORTABLE BREWING VESSEL

(71) Applicant: Catalyst Inventions LLC, Norcross, GA (US)

(72) Inventors: Jordan Warren, Norcross, GA (US); James Trezza, Norcross, GA (US)

(21) Appl. No.: 14/722,195

(22) Filed: May 27, 2015

(51) Int. Cl. A47J 31/40; A47J 31/44; A47J 31/00

(52) U.S. Cl. CPC A47J 31/405; A47J 31/005; A47J 31/4403

(57) ABSTRACT

Embodiments of the present disclosure may be used to brew heated beverages. Such embodiments may be comprised of a power source, a heating element coupled to the power source, a vessel for containing liquid, and a means for releasing a brewing substance into an interior volume of the vessel.

### FIELD OF DISCLOSURE

The present disclosure generally relates to portable brewed-beverage vessels.

### BACKGROUND

Individuals often drink hot beverages, such as coffee, on-the-go. Yet in order to brew hot beverages, these individuals currently need cumbersome, non-portable devices in order to heat the water, and/or brew their beverages. Then, these individuals need to transfer the heated beverage into a cup or vessel to transport their brewed beverage.

### BRIEF OVERVIEW

A hot beverage brewer and vessel may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present disclosure may be used to brew heated beverages. Such embodiments may be comprised of a power source, a heating element coupled to the power source, a vessel for containing liquid, and a means for releasing a brewing substance into an interior volume of the vessel.

Embodiments of the present disclosure may be used as a coffee vessel that is also a coffee maker. Embodiments may brew coffee inside of the vessel. It may use, but is not limited to using, a proprietary coffee, Hey Joe Coffee™. Embodiments of the present disclosure may utilize a lithium polymer battery to power a heating element within the vessel. The heater may enable embodiments to heat water to, for example, but not limited to, 140° F.-160° F. Embodiments may brew coffee in the same way tea is made, by steeping instead of using a drip coffee system or pressure. A special blend of coffee designed specifically to compliment this system of brewing may be used. The special blend of coffee may be provided, for example, in pods. Embodiments may be comprised of a power button that enables the user to heat the water up by pushing it. A battery may be implemented for powering embodiments of the present disclosure. The battery may be comprised of, but not limited to, a lithium polymer battery, such as, for example #18650, and may utilize multiple cells. The battery may be detached and charged separately. Embodiments may provide a means for dispensing coffee.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates an embodiment of a portable brewing vessel;

FIG. 1B illustrates a see-through embodiment of the portable brewing vessel;

FIG. 1C illustrates another see-through embodiment of the portable brewing vessel;

FIG. 2A illustrates an embodiment of a vessel portion;

FIG. 2B illustrates a see-through embodiment of the vessel portion;

FIG. 3 illustrates internal components of the vessel portion;

FIG. 4 further illustrates internal components of the vessel portion;

FIG. 5A illustrates an embodiment of a battery pack;

FIG. 5B illustrates a see-through embodiment of the battery pack;

FIG. 6 illustrates a coupling between the battery and the vessel;

FIG. 7A illustrates an embodiment of a lid assembly;

FIG. 7B illustrates a see-through embodiment of the lid assembly;

FIG. 7C illustrates another embodiment of the lid assembly; and

FIG. 7D illustrates another see-through embodiment of the lid assembly.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of brewing coffee, embodiments of the present disclosure are not limited to use only in this context. For example, embodiments of the present disclosure may be used in brewing tea and other brewed beverages.

I. Overview

Consistent with embodiments of the present disclosure, a hot beverage brewer and vessel may be provided. This overview is provided to introduce a selection of concepts in a simplified form that are further described below. This overview is not intended to identify key features or essential features of the claimed subject matter. Nor is this overview intended to be used to limit the claimed subject matter's scope. The hot beverage brewer and vessel may be used by individuals or companies to brew hot beverages and transport them.

Embodiments of the present disclosure may provide a portable brewing vessel that is configured for brewing, storing and dispensing hot beverages. Accordingly, embodiments of the present disclosure may be used to brew, for example, coffee, while, with the same device, provide a portable means from which a user may drink the brewed coffee.

The first portion of the portable brewing vessel may comprise a vessel. In some embodiments, the vessel may be insulated. Further, in some embodiments the vessel may be, in part, comprised of stainless steel.

The vessel may be configured to receive a lid. In some embodiments, a sealing mechanism, such as, for example, a gasket or O-ring may be implemented in sealing a union between the lid and the vessel. The lid may be comprised of one or more holes for, for example, dispensing liquid and providing air intake. In some embodiments, a covering or plugging mechanism may be provided to cover or plug the one or more holes may to make the vessel water-tight. The covering or plugging mechanism may attach to the lid via a hinge. In some embodiments the one or more holes may be plugged with overmolded parts.

The next portion of the brewing vessel may comprise a brewing substance dispensing mechanism. The brewing substance dispensing mechanism may receive a brewing substance. For example, coffee may be inserted into the dispensing mechanism. In some embodiments, the brewing substance may comprise, for example, a brewing packet. The brewing substance dispensing mechanism may be configured to lower the brewing substance into the vessel for steeping. This brewing method may mimic the way tea is made (e.g., by steeping). In some embodiments the brewing substance dispensing mechanism may mount to the lid.

For example, a pod mechanism (a means for holding the brewing substance) may be lowered into the water by a clamp that holds the coffee or tea pod. The clamp may allow the pod to remain in a fixed position while steeping in the water. The clamp may either be attached to the bottom side of the lid or, in some embodiments, me be a part of a tray that is lowered into the coffee through the lid itself. Once brewing is complete (after a predetermined time), the pod may be retracted back into the lid. In some embodiments, brewing may be done automatically with a SOC configuration enabling an automated lowering/retracting mechanism to be activated based on, for example, a timer or user-commands.

In some embodiments, the portable brewing vessel may be configured to be used with a proprietary blend of coffee, such as, for example, Hey Joe Coffee™. The proprietary blend may be a special blend of coffee packaged to complement the configuration of the portable brewing vessel. The proprietary blend may be comprised of, but not limited to, for example, instant coffee and coffee grounds.

A portion of the brewing vessel may comprise a heating element. The heating element may be configured to heat the liquid within the vessel. In this way, the liquid stored by the vessel may be heated to, for example, 160 degrees Fahrenheit.

The heating element may be powered by a power source. The power source may be, for example, a rechargeable lithium polymer battery. In some embodiments, the battery may be detached and charged separately. Consistent with embodiments of the present disclosure, the vessel may be transported without the battery attachment. In this way, a user may store and dispense liquid using the vessel without the added weight of a battery attachment. Some embodiments of the present disclosure may be configured to receive power from an outside source, such as, for example, but not limited to, a car charger.

A power button may be provided to enable the user to switch on or off the heating mechanism. The heating mechanism may further be configured to automatically turn off after receiving a trigger such as, for example, certain amount of time has passed since being turned on, or a thermocouple reaches a certain temperature.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Configuration

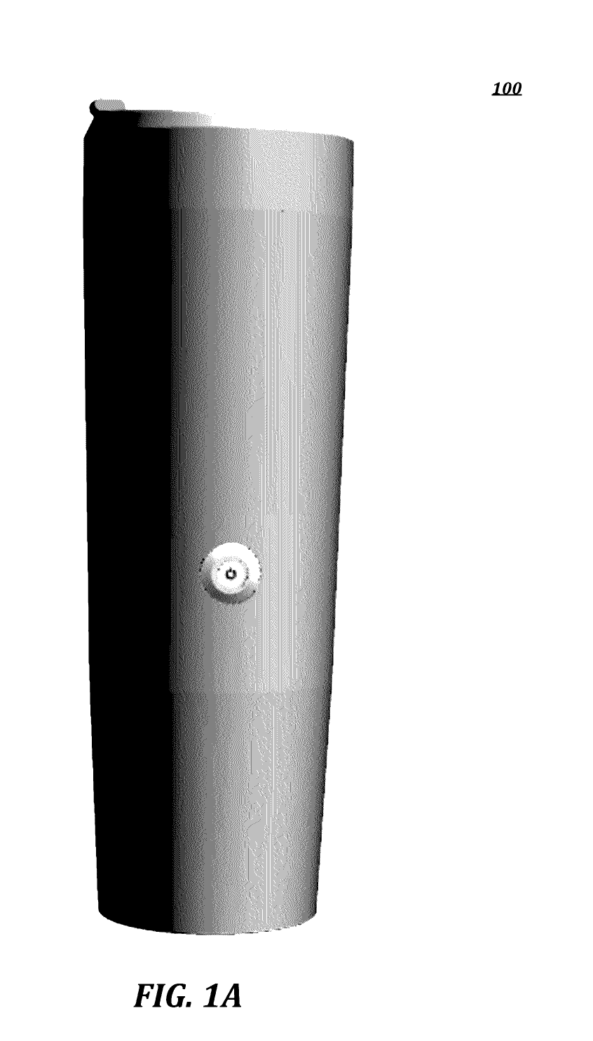

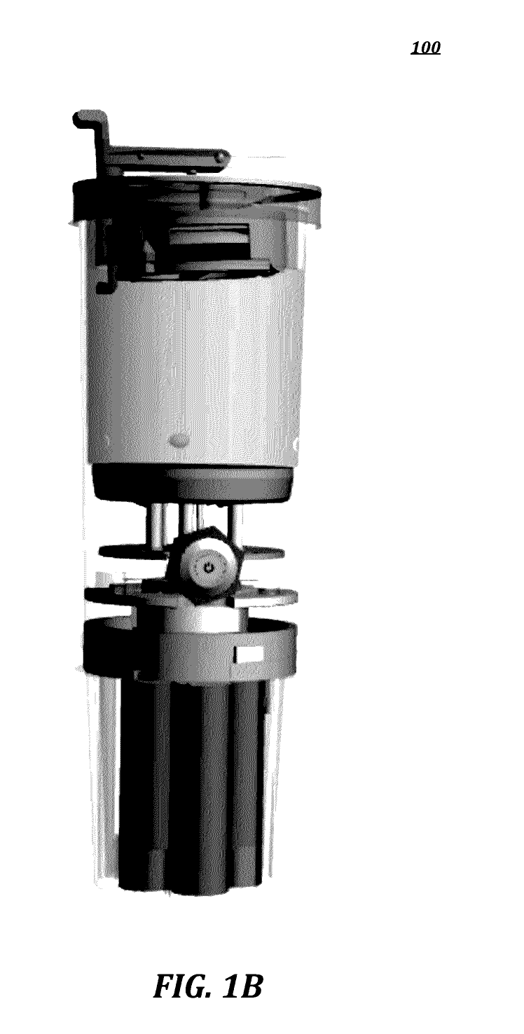

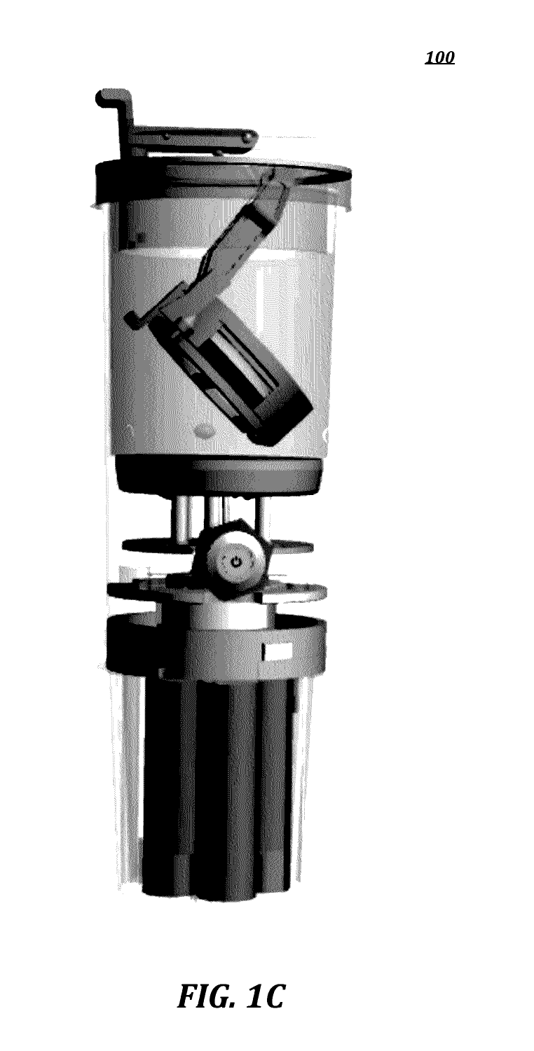

FIG. 1A, FIG. 1B and FIG. 1C illustrate an embodiment of the portable brewing vessel. The portable brewing vessel may be comprised of a vessel 200, a power source 500, and a lid 700. The power source may be, for example, a battery. The battery may be configured to receive power from an external power source, such as, for example, but not limited to, an AC-DC converter, automobile outlet adapter, or wall outlet plug. Further, some embodiments may be configured with a means to receive power directly from an outside source (e.g., an AC-DC converter, automobile outlet adapter, or wall outlet plug) without requiring the use of a battery.

The vessel may be configured to receive, store, and dispense liquids. The present disclosure will be written with reference to water as a preferred liquid, although the vessel may be configured to receive, store, and dispense any suitable liquid. Accordingly, the vessel may be designed to store water at high temperatures while maintaining a low exterior temperature for handling.

The vessel may further be configured to mate with the power source. The vessel may be configured to use the power source to heat the water stored within the interior of the vessel. In addition, the vessel may be configured to mate with a lid. Such vessel-lid mating may be water-tight in order to prevent leakage. The lid may be configured with holes for drinking. As will be detailed below, the lid may further be configured to release a brewing substance, such as, for example, coffee or tea, into the vessel.

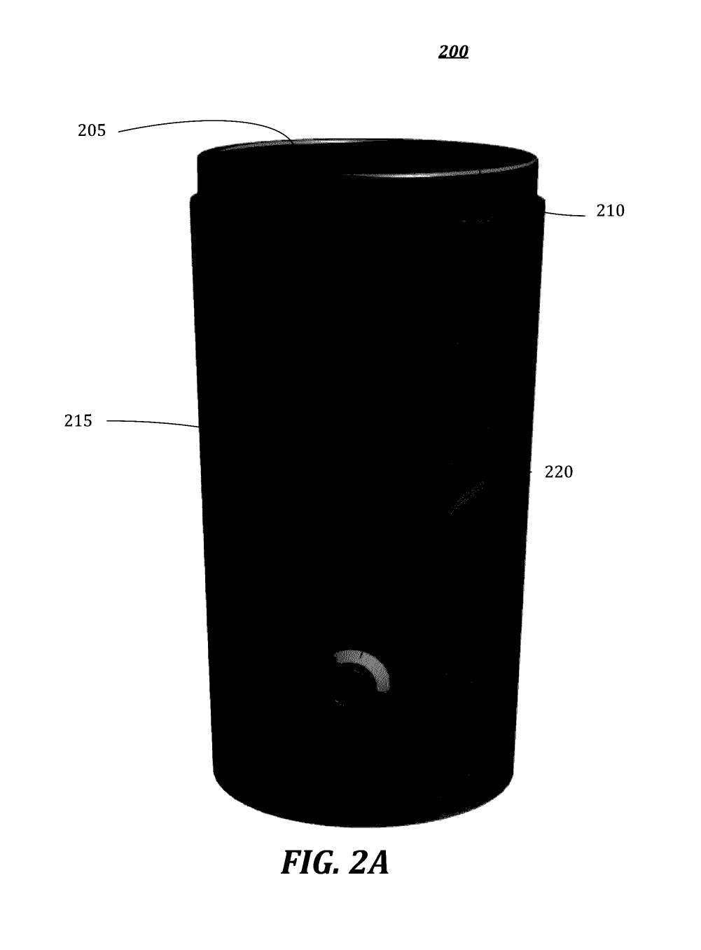

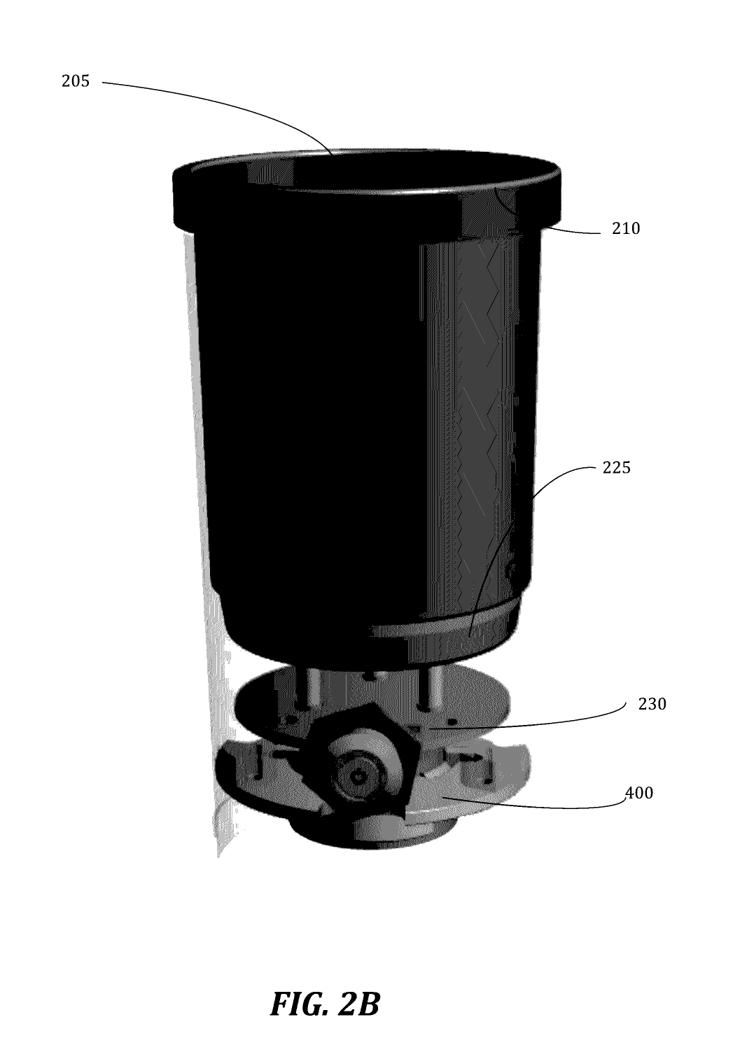

FIG. 2A illustrates an embodiment the vessel consistent with embodiments of the present disclosure. The inner liner 205 and lip edge 210 may be made of a temperature and corrosion resistant material, such as, for example stainless steel. External surfaces 215 may be cosmetic and may have a finish, such as, for example, but not limited to, medium-fine sandblast finish similar to MT1055-2. In various embodiments, a power button 220 may be present on the side of the vessel. In other embodiments, power button 220 may be located on different portions of the portable brewing vessel. The power button 220 may be used to turn the heater on and off. The power button 220 may use, for example, E-Switch PV6F240SS-41-M01. In some embodiments, polarity alignment dots may be included to enable the user to properly align the power source. The polarity alignment dots may be, for example, indentations or protrusions, and, in some embodiments, may be made during a molding process.

FIG. 2B is a see-through illustration of a vessel consistent with embodiments of the disclosure. A printed circuit board (PCB) 230 may provide control for a heating element 225 embedded within the vessel and operational associations with the power-supply and power button 120. PCB 230 may attach to the heating element to minimize wire length from the PCB 230 to the heating element. Alternatively, the PCB 230 may attach to the bottom of the plate. A second battery contact 400 may enable the battery to connect to the electrical components of the vessel. In some embodiments, the vessel may contain a charging port. The port may be configured to receive power from an outside source in order to power electrical components (e.g., heater and PCB 230) and/or charge the battery. For example, the port may be capable of receiving an AC or DC power plug. In some embodiments, the vessel and port may be configured to mate with a power docking station. For example, embodiments may be configured to receive electrical leads from a docking station when placed upon or against the docking station. Such a configuration may enable easy charging. In other embodiments, the docking station may be used to power the vessel directly, or in addition to, charging the battery.

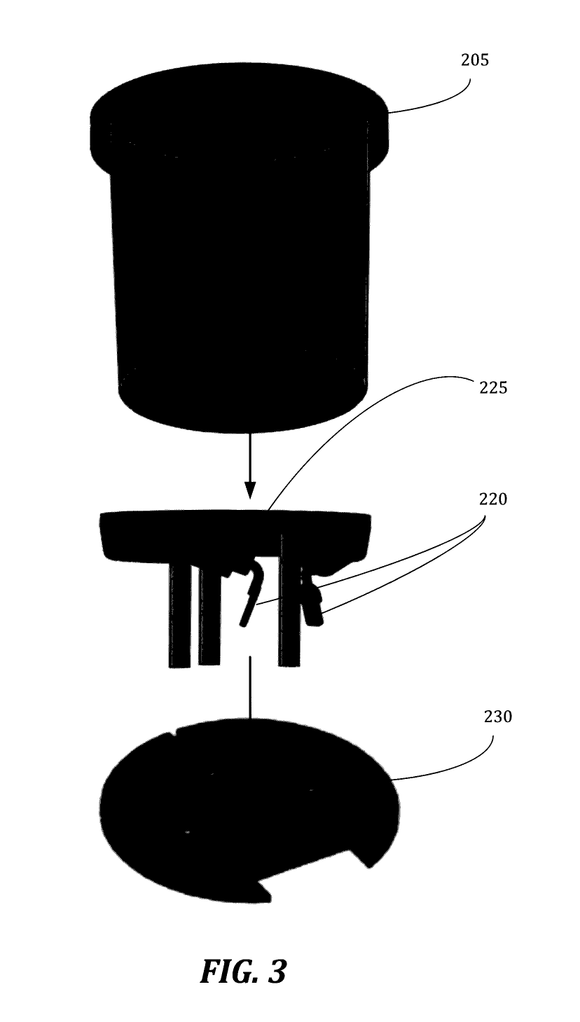

FIG. 3 is an illustration of a heating element sub-assembly consistent with embodiments of the present disclosure. A heating element 225 may be constructed of heat and corrosion resistant material, such as, for example, brushed stainless. The electronics may be designed to incorporate, for example, but not limited to, a 1.6 ohm heating element. A ledge may be used on the heating element to facilitate dry-fit and welding of inner heating element to the inner liner. Electrical connections 220 may connect the heating element 220 to an electrical including the power source, PCB 230 and power button 220.

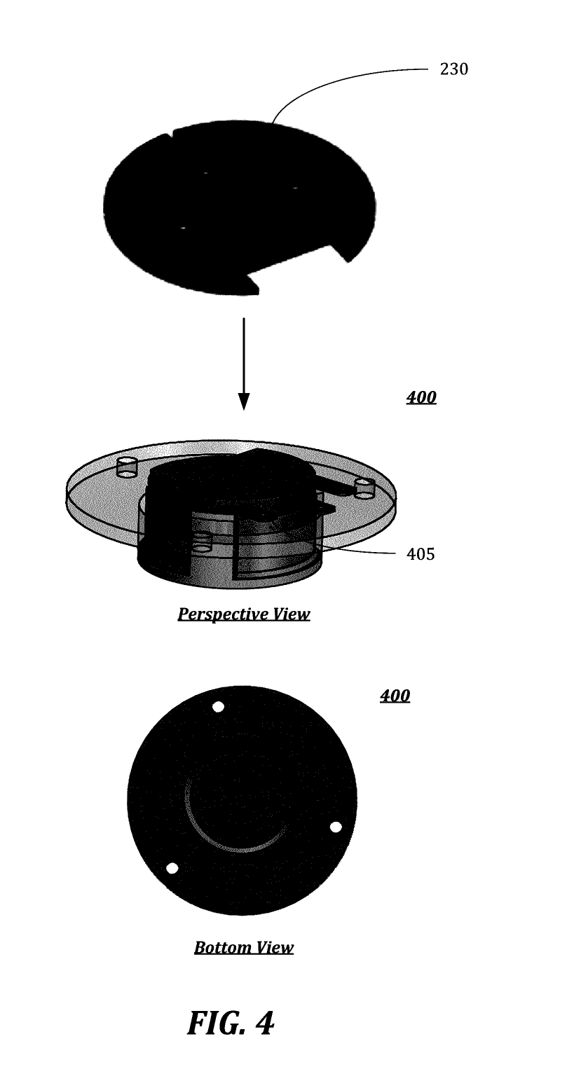

FIG. 4 is an illustration of a power source connection sub-assembly consistent with embodiments of the present disclosure. Electrical leads 405 may be configured to connect to components within the interior of the vessel.

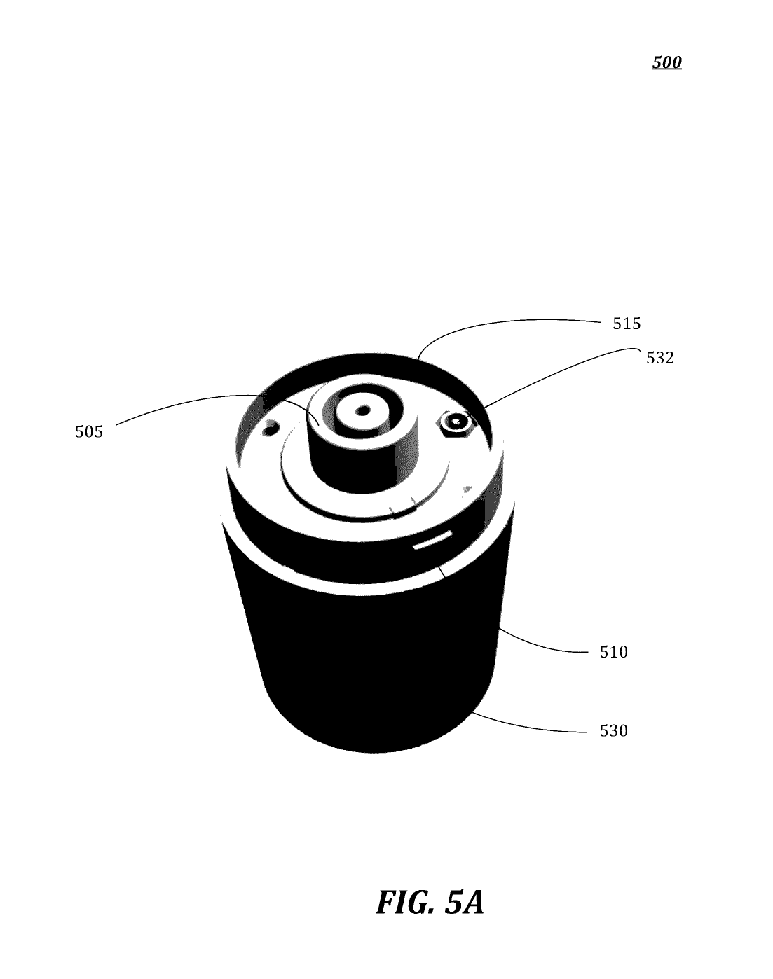

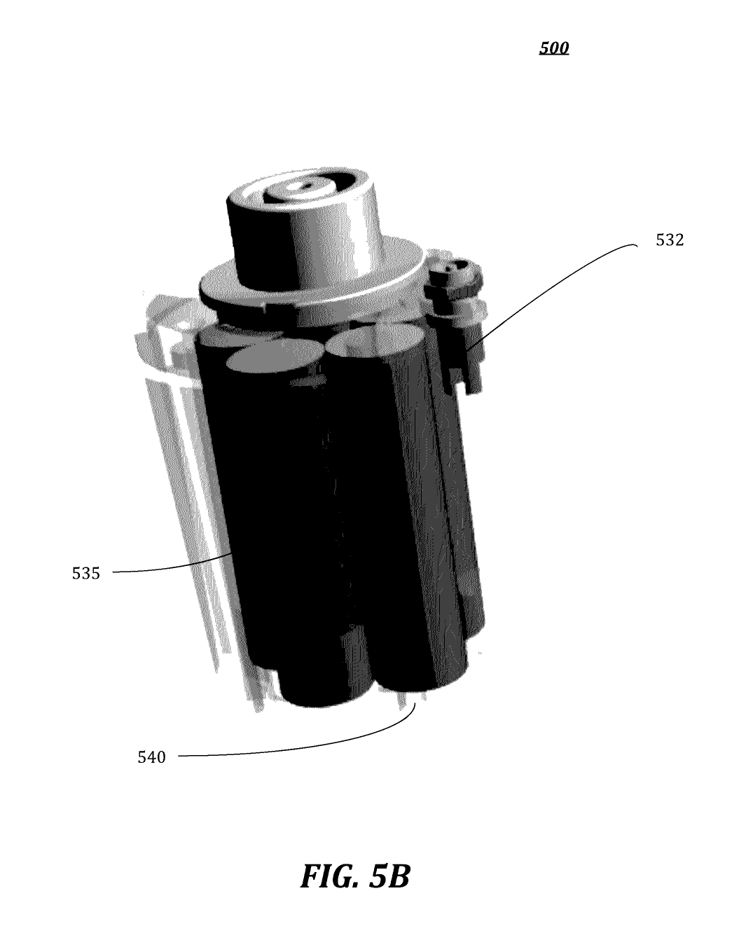

FIG. 5A is an illustration of an embodiment of a battery pack consistent with embodiments of the present disclosure. While the power source will hereinafter be referred to as a battery, the power source may be interchangeable with any other power source. A first battery contact 505 may mate with the second battery contact 400. A guiding ridge 515 may be configured to provide a snug fit between the battery and the vessel. Spring fingers 510 may snap against the bottom of the vessel to hold the battery and prevent it from rotation. The battery housing 530 may match that of the vessel. In some embodiments, the battery housing 530 may be detachable. A power reception jack 532, such as, for example a barrel jack, may receive a charging plug for charging the battery.

FIG. 5B illustrates a see-through embodiment of a battery pack consistent with embodiments of the present disclosure. Battery cells 535 may be, for example, Tenergy LiFePo4 18650 3.2V 1100 mAH batteries. The cells 535 may connect in series or in parallel. Spacers 540 may be included for holding cells of the battery in place.

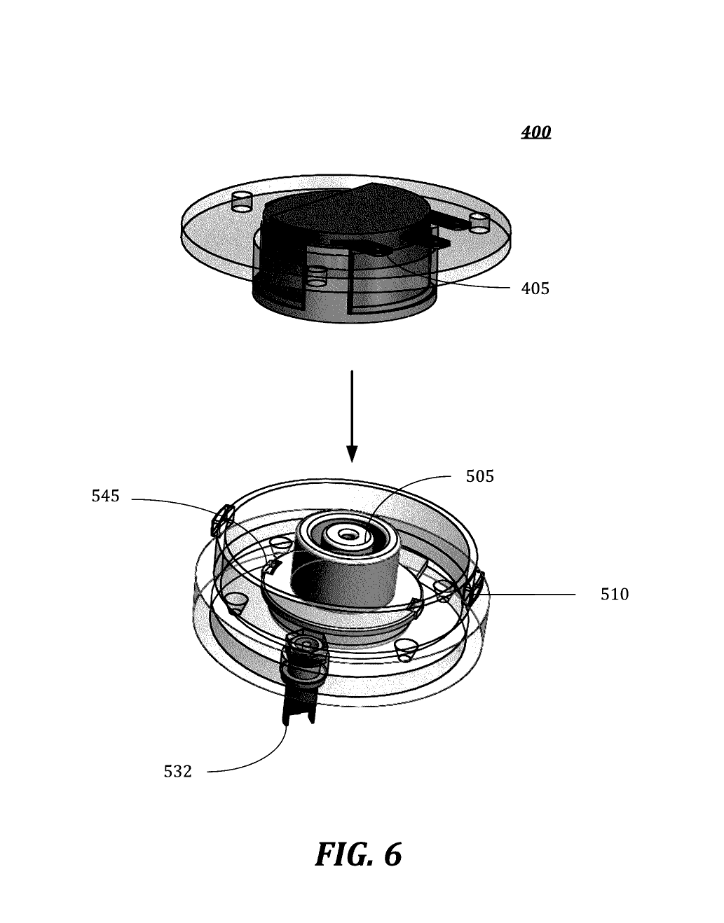

FIG. 6 is a sub-assembly illustrating one configuration in which the second battery contact and first battery contact may mate. Protrusion 545 may be present to fix the first battery contact 505 to the battery.

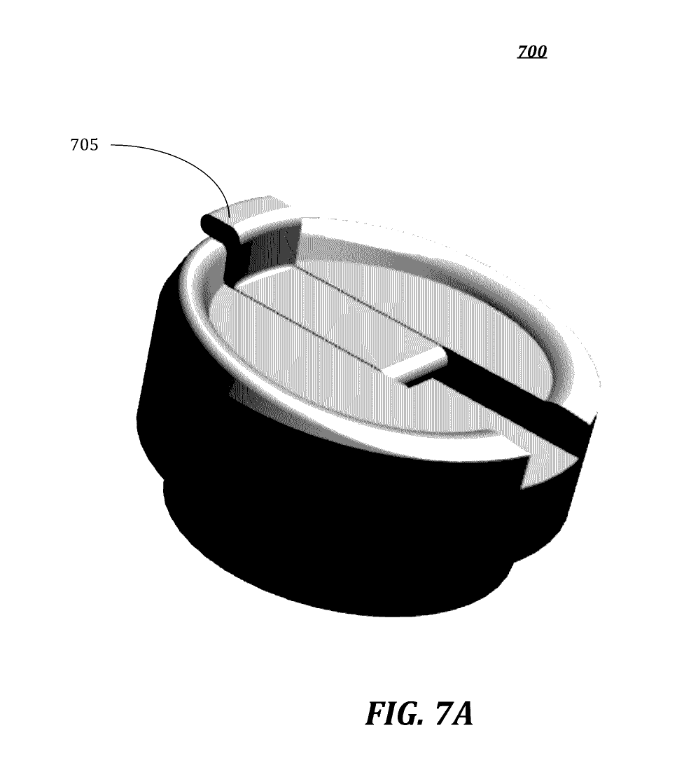

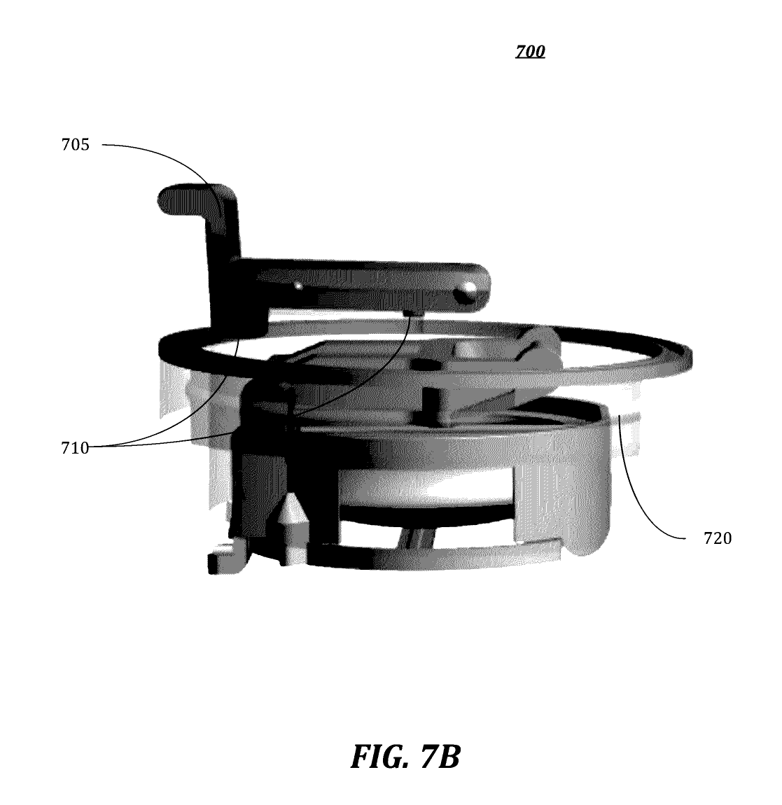

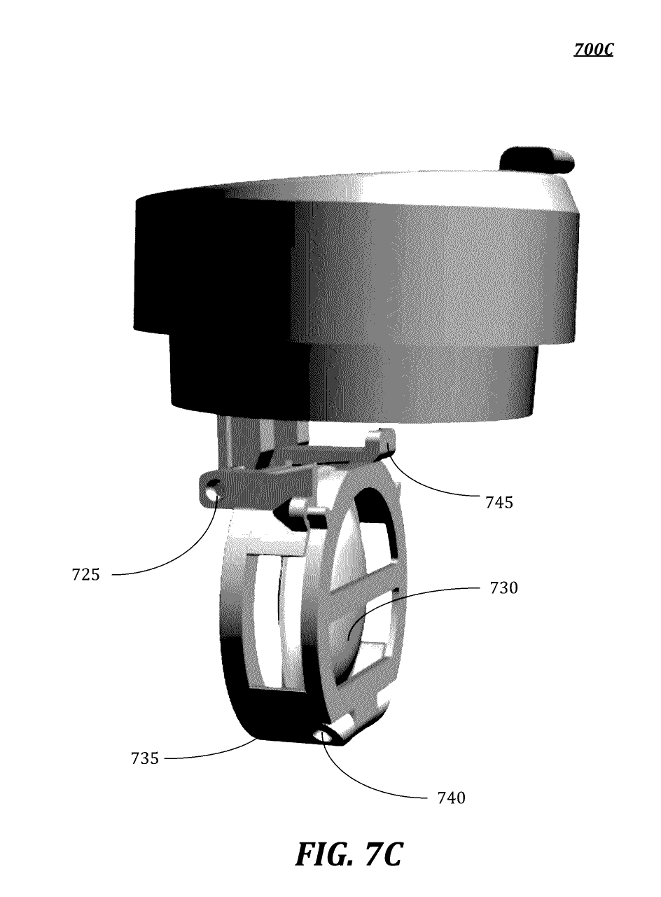

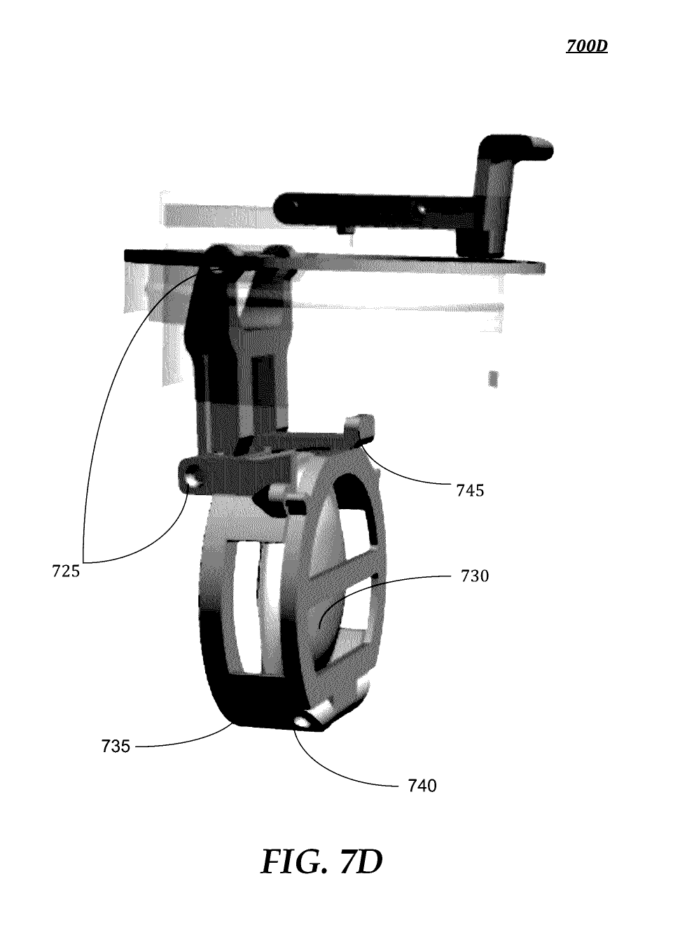

FIG. 7 is an embodiment of the lid assembly. In some embodiments, he lid may be comprised of material to match that of the vessel. Drinking hole cover 705 may cover the opening from which a user would drink from the vessel. Beneath drinking hole cover 705 may be a hole for dispensing the water. In addition, there may be a hole for providing air intake to further enable dispensing. Gasket 720 may provide a mechanism for sealing the lid to the vessel.

FIG. 7B is another embodiment of the lid assembly. Drinking hole cover 705 may contain protrusions 710 to block the holes that enable dispensing the water. In some embodiments, the protrusions 710 may be manufactured as overmolded parts. Protrusions 710 may sit over or fit tightly into their corresponding holes to prevent leaking.

FIGS. 7C and 7D illustrate an embodiment of the lid assembly with the brewing substance 730 lowered into the interior volume of the vessel to enable submersion within the water. Hinges 725 may be implemented to lower the brewing substance into the water. The hinges 725 may be, for example, pinned hinges or snap-on hinges. Brewing substance may be provided in a pod 730. Pod 730, in addition to a brewing substance, may comprise, for example, a disposable filter material or a reusable screen material. The reusable screen material may be configured to be refilled. The brewing substance may be contained within a brewing substance holding mechanism 735. The brewing substance holding mechanism 735 may be accessed by utilizing a hinge 740. The brewing substance 730 held within the brewing substance holding mechanism 735 by snap 745. In some embodiments, the snap 745 may be made steel-safe such that the level and engagement may be adjusted.

The brewing substance may be lowered when a user pulls directly on the brewing substance holding mechanism 735. Further, a lever may be employed in dropping or lowering the holding mechanism 735. Such a lever may let gravity lower the brewing substance via free-swinging hinges, or in some embodiments, the lever may mechanically drive the brewing substance down into the vessel. In some embodiments, the holding mechanism may be lowered into the 735 electronically.

III. Operation

As an example, operation will be described for brewing a cup of coffee. However, the method may be used for brewing any other hot beverage. Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method @00 will be described in greater detail below.

First, the battery may be charged. The battery may receive charge, for example, by receiving a power plug in the power reception jack. Then, the battery may be attached to the vessel, by aligning the components described in the Configuration section. The lid may receive a pod of coffee in the pod basket. The lid may then be affixed to the vessel. Next, the power button may be depressed in order to heat the water. The water may be heated to, for example, 160° F. Once the water is heated, the battery may be removed. Then, the hinges attached to the brewing substance holding mechanism may be utilized to lower the coffee pod into the heated water. Then, the drinking hole cover may be removed from the drinking hole for dispensing of brewed coffee.

IV. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1: An apparatus comprising:
a vessel configured to contain a liquid within an interior of the vessel;
a heater in contact with at least a portion of the vessel, wherein the heater is configured to: receive power from a power source and heat the interior of the vessel;
a lid configured with at least one hole for enabling a dispensing of a contents of the interior of the vessel;
a brewing substance holding mechanism for holding a brewing substance; and
a means for lowering the brewing substance holding mechanism into the interior of the vessel.

2: The apparatus of claim 1, wherein the brewing substance holding mechanism is contained, at least in part, within an interior of the lid.

3: The apparatus of claim 2, wherein the means for lowering the brewing substance holding mechanism is configured to lower the brewing substance holding mechanism from the interior of the lid into the interior of the vessel.

4: The apparatus of claim 1, wherein the means for lowering the brewing substance holding mechanism is further configured to retract the brewing substance holding mechanism back to its Original position.

5: The apparatus of claim 1, wherein the power source is a battery, and the battery is configured to be detachably coupled to the vessel.

6: The apparatus of claim 1, further comprising a docking station comprising the power source, wherein the docking station is configured to be coupled to the vessel.

7: The apparatus of claim 1, wherein an exterior of the vessel is insulated from the interior.

8: The apparatus of claim 1, wherein an exterior of the vessel has circular cross-sections.

9: The apparatus of claim 1, wherein the brewing substance holding mechanism is coupled to at least one hinge with a resistance.

10: The apparatus of claim 9, further comprising a release lever, wherein, upon a moving of the release lever, the hinge is configured to cause a lowering and raising of the brewing substance holding mechanism into the interior of the vessel.

11: The apparatus of claim 1, further comprising a power button configured to couple and decouple the power source and the heater.

12: The apparatus of claim 1, further comprising a controller configured to decouple the heater and the power source upon a condition.

13: The apparatus of claim 12, wherein the condition is an amount of time.

14: The apparatus of claim 12, further comprising a temperature-sensing device, wherein the condition is a registered temperature from the temperature-sensing device.

15: An apparatus comprising:
a vessel, comprising an interior, configured to contain a liquid within the interior;
a heater coupled to the vessel and configured to heat the liquid;
a battery configured to power the heater;
a lid configured with at least one hole for enabling a dispensing of the liquid; and
a brewing substance holding mechanism configured to receive a brewing substance; and
a means for lowering and retracting the brewing substance holding mechanism to and from the interior of the vessel.

16: The apparatus of claim 15, wherein the brewing substance holding mechanism is contained, at least in part, within an interior of the lid.

17: The apparatus of claim 15, wherein the battery is configured to be detachably coupled to the heater.

18: The apparatus of claim 15, further comprising a docking station configured to couple and decouple the battery from the heater.

19: A system comprising:
a vessel, comprising an interior, configured to receive a liquid;
a heater coupled to the vessel;
a power source configured to be coupled to and decoupled from the heater; and
a lid configured to attach to the top of the vessel, the lid comprising:
at least one hole for enabling a dispensing of the liquid, and
a brewing substance holding mechanism for receiving a brewing substance, and
a hinge for lowering and retracting the brewing substance holding mechanism to and from the interior of the vessel.

20: The system of claim 19, wherein the heater is contained within the vessel.
